(19) United States
(12) Patent Application Publication
(10) Pub. No.: US 2016/0248966 A1
(43) Pub. Date: Aug. 25, 2016

(54) METHOD AND APPARATUS FOR AIDING AUTOMATIC FOCUSING AND ELECTRONIC EQUIPMENT

(71) Applicant: Sony Corporation, Tokyo (JP)

(72) Inventors: Yingying QIN, Beijing (CN); Fang CHEN, Beijing (CN)

(21) Appl. No.: 14/772,607

(22) PCT Filed: May 19, 2015
(86) PCT No.: PCT/IB2015/053694

§ 371 Date: Mar. 16, 2016

(30) Foreign Application Priority Data
Nov. 25, 2014 (CN) 201410686232.7

(51) Int. Cl. H04N 5/232; G03B 13/36; G06K 9/00

(52) U.S. Cl. CPC H04N 5/23212; H04N 5/23219; G06K 9/00261; G03B 13/36

(57) ABSTRACT

A method and apparatus for aiding automatic focusing and electronic equipment. The method includes: detecting a subject, so as to obtain a selected region of the subject; and performing aided automatic focusing on the subject according to a change of the selected region of the subject. With the embodiments of the present disclosure, focusing is performed on the subject according to a change of the selected region of the subject, thereby reducing some steps of automatic focusing and scanning, improving performance of automatic focusing, saving time for focusing, and increasing efficiency of focusing.

### CROSS-REFERENCE TO RELATED APPLICATION AND PRIORITY CLAIM

This application claims the priority benefit of Chinese Patent Application Serial No. 201410686232.7, filed Nov. 25, 2014, the entire disclosure of which is hereby incorporated by reference.

### TECHNICAL FIELD

The present disclosure relates to the field of automatic focusing, and in particular to a method and apparatus for aiding automatic focusing and electronic equipment.

### BACKGROUND ART

Automatic focusing is one of key technologies of a modern imaging system, and with the development of facial recognition technologies, automatic focusing technologies based on facial recognition are widely used. When automatic focusing based on facial recognition is used, a focusing region varies along with a region of interest of the face. The face may move rightwards, leftwards, upwards, downwards, far away, or closely etc., and all the actions may activate automatic focusing scanning.

### SUMMARY

In the implementation of the present disclosure, the inventors found that when the face moves rightwards, leftwards, upwards or downwards, the coordinates of the facial region will change, but a size of the facial region may not change. And if re-focusing is performed, a load of the automatic focusing is increased. Likewise, when the face moves farther away or closer, the size of the facial region changes.

However, existing methods cannot determine whether the face is moving farther away or closer, which also increases the load (e.g., work load) of the automatic focusing.

In order to solve the problems put forward in the Background Art, embodiments of the present disclosure provide a method and apparatus for aiding automatic focusing and electronic equipment, so as to improve performance of automatic focusing.

It is noted here that although the several embodiments and examples described below present description with respect to facial tracking and/or focusing with respect to the face of a subject, it will be appreciated that the disclosure also relates to object tracking and/or focusing, e.g., tracking and/or focusing with respect to virtually any object, whether a face of an individual, body of an individual or a part of virtually any other animate or inanimate object. Thus, the terms “subject” and “object” may be used interchangeably and equivalently, as will become apparent from the following description.

According to a first aspect of the embodiments of the present disclosure, there is provided a method for aiding automatic focusing, including: detecting a subject, so as to obtain a selected region of the subject; and performing aided automatic focusing on the subject according to a change of the selected region of the subject.

According to a second aspect of the embodiments of the present disclosure, there is provided a method as described in the first aspect, wherein the method includes: detecting the subject by using a facial recognition technology, so as to obtain a facial region of the subject; and performing aided automatic focusing on the subject according to a change of the facial region of the subject.

According to a third aspect of the embodiments of the present disclosure, there is provided a method as described in the second aspect, wherein the performing aided automatic focusing on the subject according to a change of the facial region of the subject includes: performing focusing on the subject when a current facial region is a facial region obtained at a first time of detection; comparing the current facial region with a facial region obtained at the preceding time of detection when the current facial region is not the facial region obtained at the first time of detection; and determining whether to perform re-focusing on the subject according to a comparison result.

According to a fourth aspect of the embodiments of the present disclosure, there is provided a method as described in the third aspect, wherein, if a variable between a difference of first coordinates or a difference of second coordinates of the current facial region and a difference of first coordinates or a difference of second coordinates of a preceding facial region is less than a first threshold value, it is determined that the subject needs not to be re-focused; and if the variable between the difference of the first coordinates and the difference of the second coordinates of the current facial region and the difference of the first coordinates and the difference of the second coordinates of the preceding facial region is not less than the first threshold value, it is determined that the subject needs to be re-focused.

According to a fifth aspect of the embodiments of the present disclosure, there is provided a method as described in the fourth aspect, wherein if a difference between a variable of the difference of the first coordinates and a variable of the difference of the second coordinates is less than a second threshold value, the method further includes: determining a direction of re-focusing according to the variable of the difference of the first coordinates or the variable of the difference of the second coordinates.

According to a sixth aspect of the embodiments of the present disclosure, there is provided a method as described in the fifth aspect, wherein, if the variable of the difference of the first coordinates or the variable of the difference of the second coordinates is greater than 1, it is determined to perform re-focusing on the subject to a relatively close direction.

According to a seventh aspect of the embodiments of the present disclosure, there is provided a method as described in the fifth aspect, wherein, if the variable of the difference of the first coordinates or the variable of the difference of the second coordinates is less than 1, it is determined to perform re-focusing on the subject to a relatively far direction.

According to an eighth aspect of the embodiments of the present disclosure, there is provided an apparatus for aiding automatic focusing, including: a recognizing unit configured to detect a subject, so as to obtain a selected region of the subject; and a focusing unit configured to perform aided automatic focusing on the subject according to a change of the selected region of the subject.

According to a ninth aspect of the embodiments of the present disclosure, there is provided an apparatus as described in the eighth aspect, wherein, the recognizing unit detects the subject by using a facial recognition technology, so as to obtain a facial region of the subject; and the focusing unit performs aided automatic focusing on the subject according to a change of the facial region of the subject.

According to a tenth aspect of the embodiments of the present disclosure, there is provided an apparatus as described in the ninth aspect, wherein the focusing unit includes: a judging module configured to judge whether a current facial region is a facial region obtained at a first time of detection; a focusing module configured to perform focusing on the subject when a judgment result of the judging module is yes; a comparing module configured to compare the current facial region with a facial region obtained at the preceding time of detection when the judgment result of the judging module is no; and a determining module configured to determine whether to perform re-focusing on the subject according to a comparison result of the comparing module.

According to an eleventh aspect of the embodiments of the present disclosure, there is provided an apparatus as described in the tenth aspect, wherein, the determining module determines that the subject needs not to be re-focused when a variable between a difference of first coordinates or a difference of second coordinates of the current facial region and a difference of first coordinates or a difference of second coordinates of a preceding facial region is less than a first threshold value; and the determining module determines that the subject needs to be re-focused when the variable between the difference of the first coordinates and the difference of the second coordinates of the current facial region and the difference of the first coordinates and the difference of the second coordinates of the preceding facial region is not less than the first threshold value.

According to a twelfth aspect of the embodiments of the present disclosure, there is provided an apparatus as described in the eleventh aspect, wherein, the determining module determines a direction of re-focusing according to the variable of the difference of the first coordinates or the variable of the difference of the second coordinates when a difference between a variable of the difference of the first coordinates and a variable of the difference of the second coordinates is less than a second threshold value.

According to a thirteenth aspect of the embodiments of the present disclosure, there is provided an apparatus as described in the twelfth aspect, wherein, the determining module determines to perform re-focusing on the subject to a relatively close direction when the variable of the difference of the first coordinates or the variable of the difference of the second coordinates is greater than 1.

According to a fourteenth aspect of the embodiments of the present disclosure, there is provided an apparatus as described in the twelfth aspect, wherein, the determining module determines to perform re-focusing on the subject to a relatively far direction when the variable of the difference of the first coordinates or the variable of the difference of the second coordinates is less than 1.

According to a fifteenth aspect of the embodiments of the present disclosure, there is provided electronic equipment, including an apparatus for aiding automatic focusing, the apparatus for aiding automatic focusing being configured to: detect a subject, so as to determine a selected region of the subject; and perform aided automatic focusing on the subject according to a change of the selected region of the subject.

An advantage of the embodiments of the present disclosure exists in that with the embodiments of the present disclosure, an aiding automatic focusing is performed on the subject according to a change of the selected region of the subject, thereby reducing some steps of automatic focusing and scanning, improving performance of automatic focusing, saving time for focusing, and increasing efficiency of focusing.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth principles of the present disclosure together with the description. It is obvious that the drawings described below are embodiments of the present disclosure only, and to those skilled in the art, other accompanying drawings may be obtained according to these drawings without making an inventive effort.

In the drawings:

FIG. 1 is a flowchart of the method for aiding automatic focusing of an embodiment of the present disclosure;

FIG. 2 is a schematic diagram of a face moving rightward;

FIG. 3 is a schematic diagram of a face moving farther away;

FIG. 4 is a flowchart of a mode of implementation of the method for aiding automatic focusing of the embodiment of the present disclosure;

FIG. 5 is a schematic diagram of the structure of the apparatus for aiding automatic focusing of an embodiment of the present disclosure;

FIG. 6 is a schematic diagram of a mode of implementation of the structure of a focusing unit of the apparatus for aiding automatic focusing shown in FIG. 5; and

FIG. 7 is a schematic diagram of the structure of the electronic equipment of an embodiment of the present disclosure.

### DETAILED DESCRIPTION

The interchangeable terms “electronic apparatus” and “electronic device” include portable radio communication apparatus. The term “portable radio communication apparatus”, which hereinafter is referred to as a “mobile radio terminal”, “portable electronic device”, or “portable communication device”, comprises all apparatuses such as mobile telephones, smart phones, pagers, communicators, electronic organizers, personal digital assistants (PDAs), smart telephones, portable communication devices or the like.

In the present application, embodiments of the disclosure are described primarily in the context of a portable electronic device in the form of a mobile telephone (also referred to as “mobile phone”). However, it shall be appreciated that the disclosure is not limited to the context of a mobile telephone and may relate to any type of appropriate electronic apparatus, such as camera, video camera, tablet computer, smart watch, smart glasses, headsets, wearable device, fixed telephone, media player, game device, PDA and computer, etc.

The preferred embodiments of the present disclosure are described as follows with reference to the drawings.

### Embodiment 1

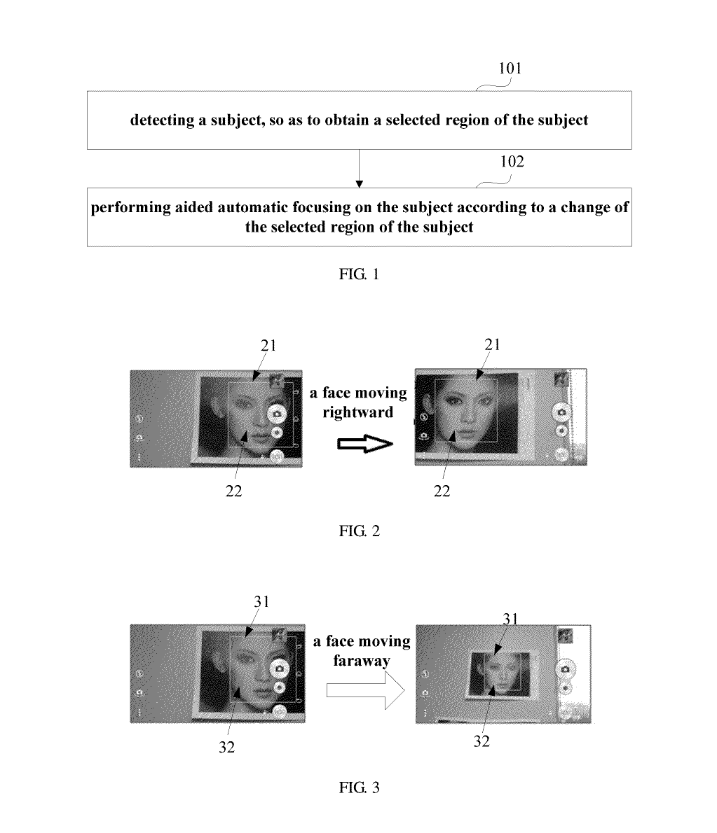

This embodiment provides a method for aiding automatic focusing. FIG. 1 is a flowchart of the method. Referring to FIG. 1, the method includes:

step 101: detecting a subject, so as to obtain a selected region of the subject; and

step 102: performing aided automatic focusing on the subject according to a change of the selected region of the subject.

In a mode of implementation of this embodiment, in step 101, a facial recognition technology is used to detect the subject, so as to obtain a facial region of the subject; and in step 102, aided automatic focusing is performed on the subject according to a change of the facial region of the subject. This embodiment shall be described below taking this mode of implementation as an example. However, it should be understood that this embodiment is not limited thereto, and other recognition technologies may also be used to obtain another selected region of the subject, and aided automatic focusing may be performed on the subject according to a change of the selected region. All the variations made within the spirits of the present disclosure are covered by the protection scope of the present disclosure.

In step 101, the facial region, i.e. a region of interest (ROR) of face, of the subject, may be obtained by detecting the subject by using facial recognition technology, and the region of interest of a face may be delimited for being exhibited to a user.

The facial recognition technology may employ feature-based recognition algorithms, appearance-based recognition algorithms, template-based recognition algorithms, recognition algorithms using neural network, etc.

The facial region may be of a rectangular shape, and may be indicated by rectangular coordinates. When the face moves towards different directions, the rectangular coordinates of the facial region obtained through detection are different. In an existing automatic focusing method, the automatic focusing scanning is activated according to the coordinates; that is, each time (e.g., each occurrence) of movement of the face activates one time of automatic focusing scanning, which greatly increasing workload of the automatic focusing scanning, lowering efficiency of the automatic focusing, and increasing power consumption.

In step 102, the automatic focusing scanning is not activated according to the coordinates of the facial region, but the automatic focusing is activated according to the change of the facial region.

In a mode of implementation, if a current facial region is obtained through a first time of detection, a focusing scanning operation is performed on the subject for one time. However, if the current facial region is not obtained through the first time of detection, that is, a facial region was detected before the current facial region, the facial regions obtained through the two times (i.e., both times) of detection are compared, and whether to perform re-focusing on the subject is determined according to a comparison result.

In a mode of implementation, if a variable between a difference of first coordinates or a difference of second coordinates of the current facial region and a difference of first coordinates or a difference of second coordinates of a preceding facial region is less than a first threshold value, such as being equal to each other, it shows that the face of the subject does not move (has not moved) in a direction parallel to the optical axis of the camera, and it is determined that the subject needs not to be re-focused.

The following description is given taken that the first coordinate is horizontal coordinate and the second coordinate is vertical coordinate as an example.

If a difference of the horizontal coordinates of the current facial region is identical to a difference of the horizontal coordinates of the preceding facial region (the variable is within a predetermined range), it is determined that the subject needs not to be re-focused. In a scenario, the face may move leftwards or rightwards only, the horizontal coordinates of the facial region change, but the difference of the horizontal coordinates does not change, and a distance between the face and the camera does not change. In such a scenario, the focus should not change, and re-focusing is not needed according to the method of this embodiment.

FIG. 2 is a schematic diagram of a face moving rightward. As shown in FIG. 2, a facial region 22 is delimited by a rectangular frame 21. When the face moves rightwards, if an existing method of automatic focusing is used, horizontal coordinates of the rectangular frame 21 change, such as changing from x1, x2 into x1′, x2′, thereby re-focusing is triggered; and if the method of this embodiment is used, although horizontal coordinates of the rectangular frame 21 change, a difference of the horizontal coordinates (x1−x2 and x1′−x2′) does not change, thereby re-focusing may not be triggered.

In this example, that the difference of the horizontal coordinates does not change refers to that a variable of the difference of the horizontal coordinates is within a predetermined range, such as (x1′−x2′)/(x1−x2)≦t1, and (x1′−x2′)−(x1−x2)≦t1, t1 being a predetermined threshold value, which is referred to as a first threshold value. The above two formulae are examples only, and in concrete implementation, other formulae may also be used to indicate the above change.

Likewise, if a difference of the vertical coordinates of the current facial region is identical to a difference of the vertical coordinates of the preceding facial region (the variable is within a predetermined range), it is determined that the subject needs not to be re-focused. In a scenario, the face may move upwards or downwards only, the vertical coordinates of the facial region change, but the difference of the vertical coordinates does not change, and a distance between the face and the camera does not change too. In such a scenario, the focus should not change, and re-focusing is not needed according to the method of this embodiment.

In this example, similarly, that the difference of the vertical coordinates does not change refers to that a variable of the difference of the vertical coordinates is within a predetermined range.

Likewise, if the difference of the horizontal coordinates of the current facial region is identical to the difference of the horizontal coordinates of the preceding facial region (the variable is within a predetermined range), and the difference of the vertical coordinates of the current facial region is identical to the difference of the vertical coordinates of the preceding facial region (the variable is within a predetermined range), it is determined that the subject needs not to be re-focused. That is, the face may translate only in upper, lower, left and right directions, and the horizontal and vertical coordinates of the facial region change, but the difference of the horizontal coordinates and the difference of vertical coordinates do not change, and the distance between the face and the camera does not change. In such a scenario, the focus should not change, and re-focusing is not needed according to the method of this embodiment.

Similarly, that the difference of the horizontal coordinates and the difference of the vertical coordinates do not change refers to that a variable of the difference of the horizontal coordinates is within a predetermined range, and a variable of the difference of the vertical coordinates is within another predetermined range, the two predetermined ranges being identical or different.

In the above scenarios, if an existing method of automatic focusing is used, as the automatic focusing is triggered according to the coordinates of the facial region, each time of movement of the face may trigger one time of automatic focusing scanning, but not each time of automatic focusing scanning is necessary, thereby greatly lowering the efficiency of focusing. With the method of this embodiment, aided automatic focusing is performed on the subject only according to the change of the facial region of the subject, thereby greatly increasing the efficiency of focusing.

In another mode of implementation, if the variable between the difference of the first coordinates and the difference of the second coordinates of the current facial region and the difference of the first coordinates and the difference of the second coordinates of the preceding facial region is not less than the first threshold value, it shows that the face of the subject move in a direction parallel to the optical axis of the camera, and it is determined that the subject needs to be re-focused.

In this mode of implementation, if a variable of the difference of the first coordinates and a variable of the difference of the second coordinates is approximate, that is, the difference between the above two variables is less than another predefined threshold, referred to as a second threshold value, a direction of re-focusing may be determined according to the variable of the difference of the first coordinates or the variable of the difference of the second coordinates.

For example, if the variable of the difference of the first coordinates or the variable of the difference of the second coordinates is greater than 1, it shows that the currently detected facial region is greater than the previously detected facial region, and it is determined to perform re-focusing on the subject to a relatively close direction.

Also, for example, if the variable of the difference of the first coordinates or the variable of the difference of the second coordinates is less than 1, it shows that the currently detected facial region is less (e.g., smaller) than the previously detected facial region, and it is determined to perform re-focusing on the subject to a relatively far direction.

FIG. 3 is a schematic diagram of a face moving farther away. As shown in FIG. 3, a facial region 32 is delimited by a rectangular frame 31. When the face moves far away, if an existing method of automatic focusing is used, horizontal and vertical coordinates of the rectangular frame 31 change, for example, the horizontal coordinates change from x1, x2 into x1′, x2′, and the vertical coordinates change from y1, y2 into y1′, y2′, thereby re-focusing is triggered. And as a direction of movement of the face is unknown (far away or closely), focusing in one direction must be attempted first. If image quality becomes poor, focusing in another direction is attempted, thereby increasing workload and lowering focusing efficiency. If the method of this embodiment is used, re-focusing is triggered only when the difference of the horizontal coordinates of the current facial region is different from the difference of the horizontal coordinates of the preceding facial region, that is, (x1′−x2′) (x1−x2), and the difference of the vertical coordinates of the current facial region is different from the difference of the vertical coordinates of the preceding facial region, that is, (y1′−y2′)≠(y1−y2). And as the difference of the horizontal coordinates and the difference of the vertical coordinates are reduced by proportion relative to the preceding differences, re-focusing is performed directly to a farther direction, thereby increasing the focusing efficiency.

In this embodiment, as describe above, if ((x1′−x2′)/(x1−x2))−((y1′−y2′)/(y1−y2)) t2, t2 being a predefined threshold value, that is, ((x1′−x2′)/(x1−x2))≈((y1′−y2′)/(y1−y2)), a direction of re-focusing may be determined. If the difference of the horizontal coordinates of the current facial region is greater than the difference of the horizontal coordinates of the preceding facial region, such as (x1′−x2′)>(x1−x2), that is, a variable of the differences of the horizontal coordinates ((x1′−x2′)/(x1−x2))>1, and the difference of the vertical coordinates of the current facial region is greater than the difference of the vertical coordinates of the preceding facial region, such as (y1′−y2′)>(y1−y2), that is, a variable of the differences of the vertical coordinates ((y1′−y2′)/(y1−y2))>1, it shows that the face moves towards a direction close to the camera. On the contrary, if (x1′−x2′)<(x1−x2), that is, the variable of the differences of the horizontal coordinates ((x1′−x2′)/(x1−x2))<1, and (y1′−y2′)<(y1−y2), that is, the variable of the differences of the vertical coordinates ((y1′−y2′)/(y1−y2))<1, it shows that the face moves towards a direction away from the camera.

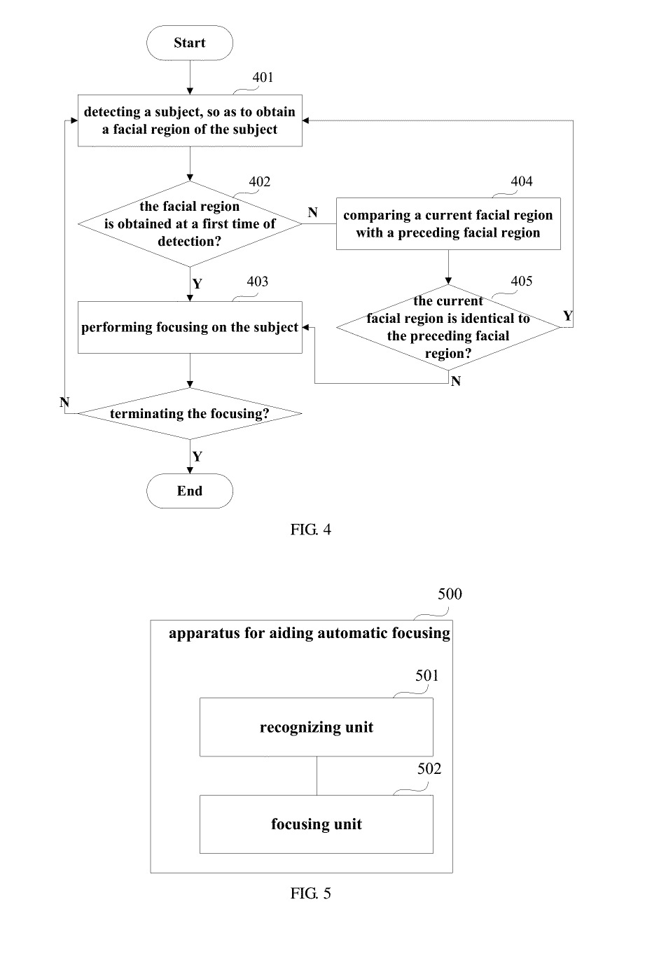

FIG. 4 is a flowchart of a mode of implementation of the method for aiding automatic focusing of the embodiment. Referring to FIG. 4, following steps are included in this mode of implementation:

step 401: detecting a subject, so as to obtain a facial region of the subject;

step 402: judging whether the facial region is obtained at a first time of detection, and executing step 403 if yes, otherwise, executing step 404;

step 403: performing focusing on the subject;

step 404: comparing a current facial region with a preceding facial region;

step 405: judging whether the current facial region is identical to the preceding facial region, executing step 403 if they are different, and turning back to step 401 if they are identical.

In step 405, if the variable between the difference of the first coordinates or the difference of the second coordinates of the current facial region and the difference of the first coordinates or the difference of the second coordinates of the preceding facial region is less than the first threshold value, it is determined that the subject needs not to be re-focused; and if the variable between the difference of the first coordinates and the difference of the second coordinates of the current facial region and the difference of the first coordinates and the difference of the second coordinates of the preceding facial region is not less than the first threshold value, it is determined that the subject needs to be re-focused.

In step 405, if the difference between the variable of the difference of the first coordinates and the variable of the difference of the second coordinates is less than the second threshold value, a direction of re-focusing may be determined according to the variable of the difference of the first coordinates or the variable of the difference of the second coordinates. If the variable of the difference of the first coordinates or the variable of the difference of the second coordinates is greater than 1, it is determined to perform re-focusing on the subject to a more close direction. And if the variable of the difference of the first coordinates or the variable of the difference of the second coordinates is less than 1, it is determined to perform re-focusing on the subject to a farther direction.

Only a process of focusing is described in FIG. 4, and an operation process of electronic equipment carrying out the method of this embodiment is not limited thereto. In a concrete process of implementation, after the focusing is finished, the electronic equipment may perform other conventional processing, such as photographing, exiting from a photographing function, standby, and turning off, etc.

With the method of this embodiment, the automatic focusing scanning is activated according the change of the facial region, thereby increasing the focusing efficiency.

### Embodiment 2

An embodiment of the present disclosure further provides an apparatus for aiding automatic focusing. As the principle of the apparatus for solving problems is similar to that of the method in Embodiment 1, the implementation of the method in Embodiment 1 is referred to for the implementation of the apparatus, and the repeated parts shall not be described any further.

FIG. 5 is a schematic diagram of the structure of the apparatus for aiding automatic focusing. As shown in FIG. 5, the apparatus 500 for aiding automatic focusing includes: a recognizing unit 501 and a focusing unit 502; wherein, the recognizing unit 501 is configured to detect a subject, so as to obtain a selected region of the subject. As is described above, the recognizing unit 501 may detect the subject by using a facial recognition technology, so as to obtain a facial region of the subject. This embodiment is not limited to a type of facial recognition technology, and the facial recognition technology mentioned in Embodiment 1 and other facial recognition technologies may be applicable to the recognizing unit 501. The facial region of the subject may be obtained by detecting the subject and as described above, the facial region may be of a rectangular shape, and is indicated by rectangular coordinates.

The focusing unit 502 is configured to perform aided automatic focusing on the subject according to a change of the selected region of the subject. For example, the aided automatic focusing is performed on the subject according to a change of a facial region of the subject. As described above, different from an existing method of automatic focusing where automatic focusing is performed according to the coordinates of the facial region, the aided automatic focusing is performed according to the change of the facial region in this embodiment.

FIG. 6 is a schematic diagram of a mode of implementation of the structure of the focusing unit 502 of this embodiment. As shown in FIG. 6, in this mode of implementation, the focusing unit 502 includes: a judging module 601, a focusing module 602, a comparing module 603 and a determining module 604.

The judging module 601 is configured to judge whether a current facial region is a facial region obtained at a first time of detection; the focusing module 602 is configured to perform focusing on the subject when a judgment result of the judging module 601 is yes. The comparing module 603 is configured to compare the current facial region with a facial region obtained at the preceding time of detection when the judgment result of the judging module 601 is no, and the determining module 604 is configured to determine whether to perform re-focusing on the subject according to a comparison result of the comparing module 603.

The determining module 604 determines that the subject needs not to be re-focused when a variable between a difference of first coordinates or a difference of second coordinates of the current facial region and a difference of first coordinates or a difference of second coordinates of a preceding facial region is less than a first threshold value. The determining module 604 determines that the subject needs to be re-focused when the variable between the difference of the first coordinates and the difference of the second coordinates of the current facial region and the difference of the first coordinates and the difference of the second coordinates of the preceding facial region is not less than the first threshold value.

The determining module 604 determines a direction of re-focusing according to the variable of the difference of the first coordinates or the variable of the difference of the second coordinates when a difference between a variable of the difference of the first coordinates and a variable of the difference of the second coordinates is less than a second threshold value.

The determining module 604 determines to perform re-focusing on the subject to a relatively close direction when the variable of the difference of the first coordinates or the variable of the difference of the second coordinates is greater than 1.

Also, the determining module 604 determines to perform re-focusing on the subject to a relatively far direction when the variable of the difference of the first coordinates or the variable of the difference of the second coordinates is less than 1.

With the method of this embodiment, the automatic focusing scanning is activated according the change of the facial region, thereby increasing the focusing efficiency.

### Embodiment 3

An embodiment of the present disclosure further provides electronic equipment, including the apparatus for aiding automatic focusing as described in Embodiment 2, the apparatus for aiding automatic focusing being configured to: detect a subject by using a facial recognition technology, so as to determine a facial region of the subject; and perform aided automatic focusing on the subject according to a change of the facial region of the subject.

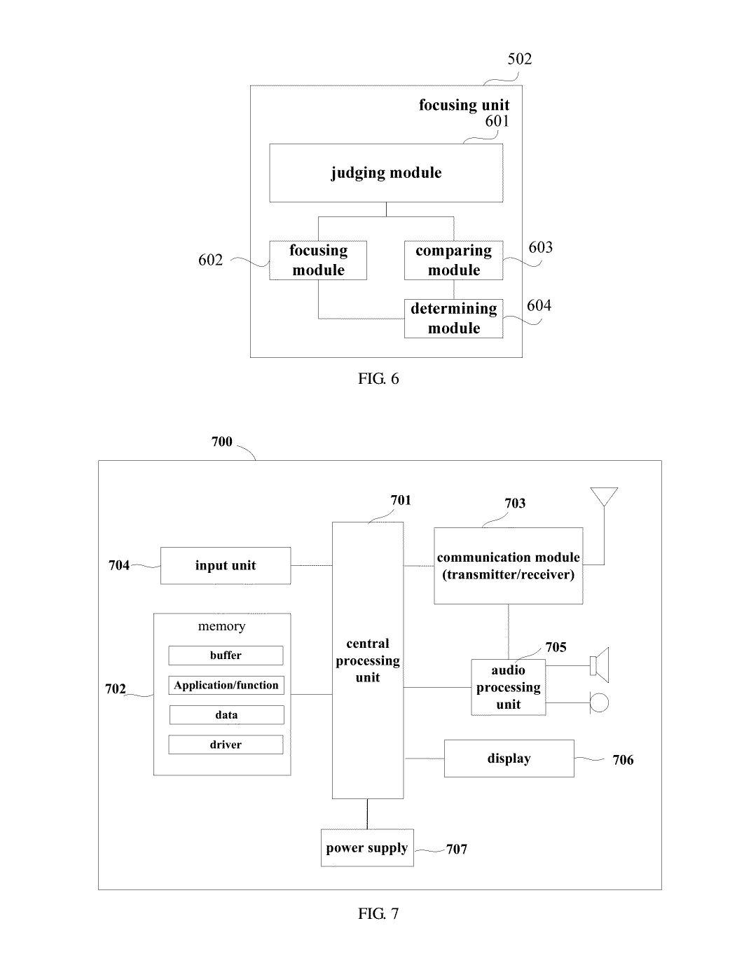

FIG. 7 is a schematic diagram of the structure of the electronic equipment 700 of the embodiment of the present disclosure. As shown in FIG. 7, the electronic equipment 700 may include a central processing unit 701 and a memory 702, the memory 702 being coupled to the central processing unit 701. It should be noted that such a figure is exemplary only, and other types of structures may be used to supplement or replace this structure for the realization of telecommunications functions or other functions.

In a mode of implementation, functions of the apparatus for aiding automatic focusing described in Embodiment 2 may be integrated into the central processing unit 701, and the central processing unit 701 carries out the functions of the apparatus for aiding automatic focusing described in Embodiment 2. The functions of the apparatus for aiding automatic focusing are incorporated herein, which shall not be described herein any further.

In another mode of implementation, the apparatus for aiding automatic focusing described in Embodiment 2 and the central processing unit 701 may be configured separately. For example, the apparatus for aiding automatic focusing may be configured as a chip connected to the central processing unit 701, with the functions of the apparatus for aiding automatic focusing being realized under control of the central processing unit 701.

As shown in FIG. 7, the electronic equipment 700 may further include a communication module 703, an input unit 704, an audio processing unit 705, a display 706, and a power supply 707. It should be noted that the electronic equipment 700 does not necessarily include all the parts shown in FIG. 7; furthermore, the electronic equipment 700 may include other parts not shown in FIG. 7, and the prior art may be referred to for these parts.

As shown in FIG. 7, the central processing unit 701 is sometimes referred to as a controller or control, and may include a microprocessor or other processor devices and/or logic devices. The central processing unit 701 receives input and controls operations of every components.

The memory 702 may be, for example, one or more of a buffer memory, a flash memory, a hard drive, a mobile medium, a volatile memory, a nonvolatile memory, or other suitable devices, which may store above information related to configuration, and may further store a program executing related information. And the central processing unit 701 may execute the program stored in the memory 702, so as to realize information storage or processing, etc. Functions of other parts are similar to those of the prior art, which shall not be described herein any further. The parts of the electronic equipment 700 may be realized by specific hardware, firmware, software, or any combination thereof, without departing from the scope of the present disclosure.

The electronic equipment may be electronic equipment having a function of photographing, such as a mobile phone, a camera, and a video camera, etc.

With the electronic equipment of this embodiment, the automatic focusing scanning is activated according the change of the facial region, thereby increasing the focusing efficiency.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although a particular feature of the present disclosure is described with respect to only one or more of the illustrated embodiments, such a feature may be combined with one or more other features of other embodiments as desired and in consideration of advantageous aspects of any given or particular application.

1. A method for aiding automatic focusing, comprising:
detecting a subject, so as to obtain a selected region of the subject; and
performing aided automatic focusing on the subject according to a change of the selected region of the subject.

2. The method according to claim 1, wherein the method comprises:
detecting the subject by using a facial recognition technology, so as to obtain a facial region of the subject; and
performing aided automatic focusing on the subject according to a change of the facial region of the subject.

3. The method according to claim 2, wherein the performing aided automatic focusing on the subject according to a change of the facial region of the subject comprises:
performing focusing on the subject when a current facial region is a facial region obtained at a first time of detection;
comparing the current facial region with a facial region obtained at a preceding time of detection when the current facial region is the facial region obtained at the first time of detection; and
determining whether to perform re-focusing on the subject according to a comparison result.

4. The method according to claim 3, wherein,
if a variable between a difference of first coordinates or a difference of second coordinates of the current facial region and a difference of first coordinates or a difference of second coordinates of a preceding facial region is less than a first threshold value, it is determined that the subject needs not to be re-focused;
and if the variable between the difference of the first coordinates and the difference of the second coordinates of the current facial region and the difference of the first coordinates and the difference of the second coordinates of the preceding facial region is not less than the first threshold value, it is determined that the subject needs to be re-focused.

5. The method according to claim 4, wherein if a difference between a variable of the difference of the first coordinates and a variable of the difference of the second coordinates is less than a second threshold value, the method further comprises:
determining a direction of re-focusing according to the variable of the difference of the first coordinates or the variable of the difference of the second coordinates.

6. The method according to claim 5, wherein,
if the variable of the difference of the first coordinates or the variable of the difference of the second coordinates is greater than 1, it is determined to perform re-focusing on the subject to a relatively close direction.

7. The method according to claim 5, wherein,
if the variable of the difference of the first coordinates or the variable of the difference of the second coordinates is less than 1, it is determined to performing re-focusing on the subject to a relatively far direction.

8. An apparatus for aiding automatic focusing, comprising:
a recognizing unit configured to detect a subject, so as to obtain a selected region of the subject; and
a focusing unit configured to perform aided automatic focusing on the subject according to a change of the selected region of the subject.

9. The apparatus according to claim 8, wherein,
the recognizing unit detects the subject by using a facial recognition technology, so as to obtain a facial region of the subject;
and the focusing unit performs aided automatic focusing on the subject according to a change of the facial region of the subject.

10. The apparatus according to claim 9, wherein the focusing unit comprises:
a judging module configured to judge whether a current facial region is a facial region obtained at a first time of detection;
a focusing module configured to perform focusing on the subject when a judgment result of the judging module is yes;
a comparing module configured to compare the current facial region with a facial region obtained at the preceding time of detection when the judgment result of the judging module is no; and
a determining module configured to determine whether to perform re-focusing on the subject according to a comparison result of the comparing module.

11. The apparatus according to claim 10, wherein,
the determining module determines that the subject needs not to be re-focused when a variable between a difference of first coordinates or a difference of second coordinates of the current facial region and a difference of first coordinates or a difference of second coordinates of a preceding facial region is less than a first threshold value;
and the determining module determines that the subject needs to be re-focused when the variable between the difference of the first coordinates and the difference of the second coordinates of the current facial region and the difference of the first coordinates and the difference of the second coordinates of the preceding facial region is not less than the first threshold value.

12. The apparatus according to claim 11, wherein,
the determining module determines a direction of re-focusing according to the variable of the difference of the first coordinates or the variable of the difference of the second coordinates when a difference between a variable of the difference of the first coordinates and a variable of the difference of the second coordinates is less than a second threshold value.

13. The apparatus according to claim 12, wherein,
the determining module determines to perform re-focusing on the subject to a relatively close direction when the variable of the difference of the first coordinates or the variable of the difference of the second coordinates is greater than 1.

14. The apparatus according to claim 12, wherein,
the determining module determines to perform re-focusing on the subject to a relatively far direction when the variable of the difference of the first coordinates or the variable of the difference of the second coordinates is less than 1.

15. Electronic equipment, comprising an apparatus for aiding automatic focusing, the apparatus for aiding automatic focusing being configured to:
detect a subject, so as to determine a selected region of the subject; and
perform aided automatic focusing on the subject according to a change of the selected region of the subject.

16. The method of any one of claims 1-7, wherein the steps are carried out using a mobile telephone.

17. The apparatus of any one of claims 8-15, comprising a mobile telephone.
